(19) United States
(12) Patent Application Publication
(10) Pub. No.: US 2017/0362008 A1
(43) Pub. Date: Dec. 21, 2017

(54) TAMPER RESISTANT FOOD CONTAINER

(71) Applicant: Vassilios Theodorakos, Framingham, ME (US)

(72) Inventor: Vassilios Theodorakos, Framingham, ME (US)

(21) Appl. No.: 15/188,857

(22) Filed: Jun. 21, 2016

(51) Int. Cl. B65D 77/32; B65D 5/42; B65D 5/02; B65D 5/66; A47J 47/14

(52) U.S. Cl. CPC B65D 77/32; B65D 5/66; A47J 47/145; B65D 5/02; B65D 5/4295

(57) ABSTRACT

A tamper resistant food container includes a top panel, a bottom panel, and an adhesive strip. The top panel includes a front section, a rear section, a front wall, opposing sidewalls, and a tear away section. The tear away section is positioned on the front wall of the top panel. The bottom panel includes a front wall, a rear wall, and opposing sidewalls. The rear wall of the bottom panel is hingedly connected to the rear section of the top panel. The top panel and the bottom panel of the tamper resistant food container define a space therebetween for storing food. The adhesive strip is positioned on an outer surface of the front wall of the bottom panel for securely sealing the top panel to the bottom panel of the tamper resistant food container. A user accesses the stored food by removing the tear away section.

### FIELD OF THE INVENTION

The invention disclosed herein relates generally to containers for freshly made food. More particularly, the invention relates to delivery containers with a tamper resistant seal for delivering freshly baked pizzas.

### BACKGROUND

Fast foods are foods sold in a restaurant with preheated or precooked ingredients. Sometimes, customers prefer fast food as a take away or home delivery option. Typically, fast food restaurants or stores deliver the food to customers in packaged form. Existing containers include containers made of cardboard panels, which are folded to define a space for storing the food, for example, pizzas, burgers, etc. However, in the existing containers, the top panels and bottom panels are interlocked to seal the container. This allows the stored content of the container to be tampered without much effort. In certain cases, contaminants may enter the container if the container is not closed carefully. Conventionally, the pizza delivery industry is focused on delivering a product as fresh as possible with less emphasis on food safety. Typically, most delivery personnel could be anyone with a car with no food safety training or food handling experience. It is not unreasonable to assume that a hungry or disgruntled employee could easily tamper with the container to cause indirect harm to the consumer. Thirty-five percent of most food borne illnesses are the direct result of unhygienic employees and most, if not all, are because of careless delivery personnel handling of the food items.

A food storage container, which is sealed securely to prevent tampering and unwanted entry of contaminants, is required. Furthermore, a customer may order multiple items from a fast food restaurant. For example, a customer may order a large pizza along with a medium pizza or garlic bread. Typically, in such cases, each item is packed separately, which is disadvantageous to delivery personnel. With multiple boxes or containers to be delivered, the delivery personnel may mix up or make mistakes while delivering the order. It is therefore advantageous if food items constituting multiple orders from a single customer is stored in a single container. A container, which stores multiple food items, is required.

Hence, there is a long felt but unresolved need for a food storage container, which is sealed securely to prevent tampering and unwanted entry of contaminants. Furthermore, there is a need for a container, which stores multiple food items.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein addresses the above-mentioned need for a food storage container, which is sealed securely to prevent tampering and unwanted entry of contaminants. Furthermore, the invention addresses the need for a container, which stores multiple food items. The tamper resistant food container disclosed herein comprises a top panel, a bottom panel, and an adhesive strip. The top panel comprises a front section, a rear section, a front wall, opposing side walls, and a tear away section. The tear away section is positioned on the front wall of the top panel. The bottom panel comprises a front wall, a rear wall, and opposing side walls. The rear wall of the bottom panel is hingedly connected to the rear section of the top panel. The top panel of the tamper resistant food container and the bottom panel of the tamper resistant food container define a space therebetween for storing food. The adhesive strip is positioned on an outer surface of the front wall of the bottom panel for securely sealing the top panel of the tamper resistant food container to the bottom panel of the tamper resistant food container. A user accesses the stored food from the tamper resistant food container by removing the tear away section.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a top perspective view of a tamper resistant food container.

FIG. 2 exemplarily illustrates a top perspective view of a tamper resistant food container.

### DETAILED DESCRIPTION OF THE INVENTION

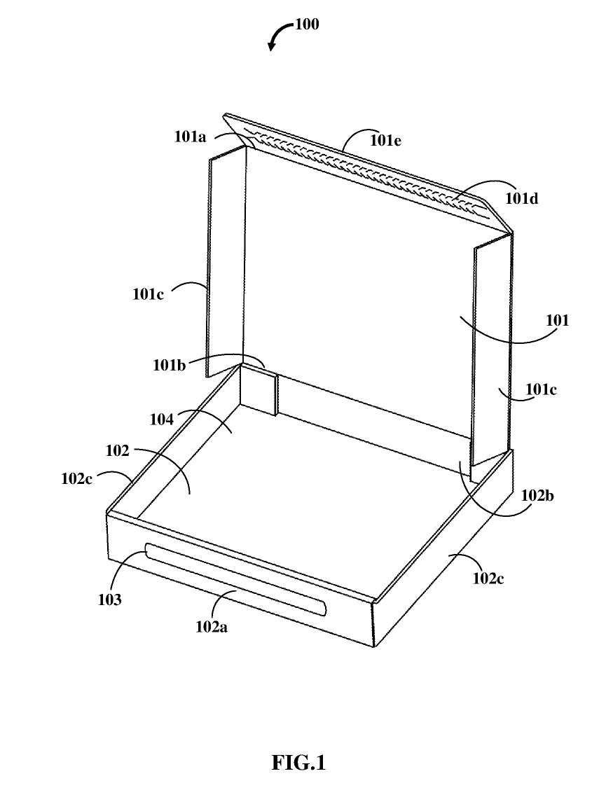

FIG. 1 exemplarily illustrates a top perspective view of a tamper resistant food container 100. The tamper resistant food container 100 comprises a top panel 101, a bottom panel 102, and an adhesive strip 103. The top panel 101 comprises a front section 101a, a rear section 101b, opposing side walls 101c, a tear away section 101d, and a front wall 101e. In an embodiment, the tear away section 101d is positioned on the front wall 101e of the tamper resistant food container 100. The user inserts his/her finger to tear or remove the tear away section 101d on the top panel 101 of the tamper resistant food container 100. The user then accesses the stored food item, for example, a pizza, etc., from the top panel 101 of the tamper resistant food container 100. The bottom panel 102 comprises a front wall 102a, a rear wall 102b, and opposing side walls 102c. In an embodiment, the rear wall 102b of the bottom panel 102 is hingedly connected to the rear section 101b of the top panel 101. In an embodiment, the top panel 101 and the bottom panel 102 of the tamper resistant food container 100 are folded into a hexagonal configuration.

The top panel 101 of the tamper resistant food container 100 and the bottom panel 102 of the tamper resistant food container 100 define a space 104 therebetween for storing food. The adhesive strip 103 is positioned on the front wall 102a of the bottom panel 102 for securely sealing the top panel 101 of the tamper resistant food container 100 to the bottom panel 102 of the tamper resistant food container 100. The delivery personnel places the food item, for example, a pizza, etc., in the space 104, and then removes the protective strip on the adhesive strip 103 and seals the tamper resistant food container 100 by attaching the top panel 101 to the bottom panel 102. Now, the only way of accessing the food item is by removing the tear away section 101d of the top panel 101. This ensures that the food item is not tampered with unnecessarily. The customer accesses the stored food from the tamper resistant food container 100 by removing the tear away section 101d of the tamper resistant food container 100 when he/she wishes to eat the food item. In an embodiment, the tamper resistant food container 100 comprises vents 105 for releasing moisture positioned on the bottom panel 102. In an embodiment, the tear away section 101d has a pull-tab for enabling a user to remove or tear the tear away section 101d of the top panel 101 of the tamper resistant food container 100 to access the food stored in the tamper resistant food container 100.

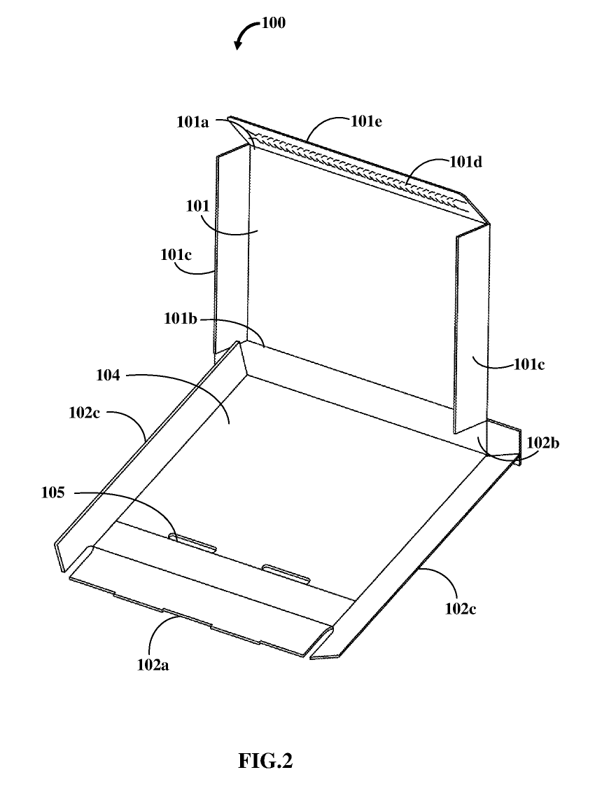

FIG. 2 exemplarily illustrates a top perspective view of a tamper resistant food container 100. In an embodiment, the tamper resistant food container 100 is made of a recyclable material, for example, a recyclable cardboard material, etc. The tamper resistant food container 100 comprises a top panel 101, a bottom panel 102, and an adhesive strip 103. The top panel 101 comprises a front section 101a, a rear section 101b, opposing side walls 101c, a tear away section 101d, and a front wall 101e. The bottom panel 102 comprises a front wall 102a, a rear wall 102b, and opposing side walls 102c. In an embodiment, the rear wall 102b of the bottom panel 102 is hingedly connected to the rear section 101b of the top panel 101. In an embodiment, the top panel 101 and the bottom panel 102 of the tamper resistant food container 100 are folded into a rectangular configuration as disclosed in the detailed description of FIG. 1. In the unfolded state, the top panel 101 and the bottom panel 102 of the tamper resistant food container 100 together have a length of about 34 inches and a width of about 16.5 inches. In another embodiment, the top panel 101 and the bottom panel 102 of the tamper resistant food container 100 together has a length of about 40 inches and a width of about 20.5 inches.

The adhesive strip 103 is positioned on the front wall 102a of the bottom panel 102 for securely sealing the top panel 101 of the tamper resistant food container 100 to the bottom panel 102 of the tamper resistant food container 100. The adhesive strip 103 is used when closing the tamper resistant food container 100 by removing a protective strip. In an embodiment, the adhesive used meets industrial food safety standards. The securely sealed tamper resistant food container 100 will thus keep all foreign objects or contaminants out of the tamper resistant food container 100. If the tamper resistant food container 100 has been tampered with, it will clearly be visible to the consumer as the only way to access the sealed tamper resistant food container 100 is by tearing the tear away section 101d of the top panel 101. Additionally, a fast food restaurant employee, for example, a manager, a cook, food handler, etc., signs on the top panel 101 ensuring the food was exactly to order, proper food handling was conducted, and the delivery personnel received and delivered the product as such. This is done based on the operator's requirement. In an embodiment, the tamper resistant food container 100 is provided with vents 105 positioned on the bottom panel 102 of the tamper resistant food container 100. The vents 105 enable moisture from the hot food to escape and ensure the food remains as fresh as possible for consumption. In an embodiment, multiple secondary containers, which are smaller in dimensions and are capable of being housed by the tamper resistant food container 100, are provided. This enables a dispatcher to store multiple food items securely within the same tamper resistant food container 100.

The foregoing examples have been provided merely for the purpose of explanation and are in no way to be construed as limiting of the tamper resistant food container 100, disclosed herein. While the tamper resistant food container 100 has been described with reference to various embodiments, it is understood that the words, which have been used herein, are words of description and illustration, rather than words of limitation. Further, although the tamper resistant food container 100, has been described herein with reference to particular means, materials, and embodiments, the tamper resistant food container 100 is not intended to be limited to the particulars disclosed herein; rather, the tamper resistant food container 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the tamper resistant food container 100 disclosed herein in their aspects.

I claim:

1. A tamper resistant food container comprising:
a top panel comprising a front section, a rear section, a front wall, opposing side walls, and a tear away section, wherein the tear away section is positioned on the front wall of the top panel;
a bottom panel comprising a front wall, a rear wall, and opposing side walls, wherein the rear wall of the bottom panel is hingedly connected to the rear section of the top panel, wherein the top panel of the tamper resistant food container and the bottom panel of the tamper resistant food container define a space therebetween for storing food;
an adhesive strip positioned on an outer surface of the front wall of the bottom panel for securely sealing the top panel of the tamper resistant food container to the bottom panel of the tamper resistant food container; and
whereby a user accesses the stored food from the tamper resistant food container by removing the tear away section.

2. The tamper resistant food container of claim 1, wherein the stored food are one or more pizzas.

3. The tamper resistant food container of claim 1, further comprising a plurality of vents for releasing moisture.

4. The tamper resistant food container of claim 1, wherein the tamper resistant food container is of a cardboard material.

5. The tamper resistant food container of claim 1, wherein the top panel is foldable.

6. The tamper resistant food container of claim 1, wherein the bottom panel is foldable.

7. The tamper resistant food container of claim 1, wherein the tear away section comprises a pull-tab for removing the tear away section and accessing the stored food.
